(19) United States
(12) Patent Application Publication
(10) Pub. No.: US 2026/0235837 A1
(43) Pub. Date: Aug. 13, 2026

(54) COMMUNICATIONS PANEL SYSTEM

(71) Applicant: CommScope Technologies LLC, Claremont, NC (US)

(72) Inventors: Scott C. SIEVERS, Jordan, MN (US); David John ANDERSON, Bloomington, MN (US); James J. SOLHEID, Minneapolis, MN (US)

(73) Assignee: CommScope Technologies LLC, Claremont, NC (US)

(21) Appl. No.: 19/474,979

(22) PCT Filed: Apr. 11, 2024
(86) PCT No.: PCT/US2024/024024

§ 371 Date: Oct. 13, 2025

Related U.S. Application Data
(60) Provisional application No. 63/496,183, filed on Apr. 14, 2023.

(51) Int. Cl. G02B 6/44

(52) U.S. Cl. CPC G02B 6/44526; G02B 6/4455

(57) ABSTRACT

A communications panel includes a chassis receiving one or more tray arrangements that each support one or more cassettes. Each cassette carries a plurality of ports at which connections are made between front and rear plug connectors. Each tray arrangement includes guides along which the cassettes slidably mount. The guides and cassettes are configured to enable cassettes of various size to mount to the same tray and releasably lock in one or more positions on the tray. Some types of guides have end tabs to help orient the cassettes. Other types of guides have flanges defining a channel for a rail of the cassette. Other types of guides have neither flanges nor end tabs.

### CROSS-REFERENCE TO RELATED APPLICATION

This application claims the benefit of U.S. Provisional Application No. 63/496,183, filed Apr. 14, 2023, titled “Communications Panel System” the disclosure of which is hereby incorporated herein by reference.

### BACKGROUND

In the telecommunications industry, the demand for added capacity is growing rapidly. This demand is being met in part by the increasing use and density of fiber optic transmission equipment. Even though fiber optic equipment permits higher levels of transmission in the same or smaller footprint than traditional copper transmission equipment, the demand requires even higher levels of fiber density. This has led to the development of high-density fiber handling equipment.

In communications panel systems, port members (e.g., optical adapters, electrical jacks, hybrid port members, etc.) defining front ports are mounted to one or more trays that are disposable within a chassis. The front ports are configured to receive plug connectors at the fronts of the trays. The trays can either be stationary within a chassis or can slide forwardly of the chassis to enhance access to the port members.

Improvements are desired.

### SUMMARY

A communications panel includes a chassis holding one or more trays. Each tray spans a width and depth of the chassis. In some implementations, the trays are stationary within the chassis. In other implementations, the trays are slidable within the chassis between two or more positions. Each tray is configured to support one or more cassettes carrying ports (e.g., optical ports, electrical ports, or hybrid ports) to receive plug connectors. A tray populated with one or more cassettes is referred to herein as a communications arrangement. The cassettes are slidably mounted to the tray along guides.

Some aspects of the disclosure are directed to guides having stop arrangements configured to engage with latching arrangements of the cassettes. In certain implementations, each stop arrangement includes first and second camming members spaced from each other by a gap. In certain examples, each camming member is no longer than the gap. In certain examples, each camming member is no longer than 0.25 times the length of the guide. In certain examples, each camming member is no longer than 0.125 times the length of the guide. In certain examples, each camming member is no longer than 0.1 times the length of the guide.

In accordance with certain aspects of the disclosure, each guide can include end tabs spaced outwardly from the stop arrangement. In certain examples, each end tab is about the same size as one of the camming members. In certain examples, each end tab is less than the length of the gap between the camming members. In certain examples, each end tab is no longer than 0.25 times the length of the guide. In certain examples, each end tab is no longer than 0.1 times the length of the guide.

In accordance with certain aspects of the disclosure, each guide can include flanges extending outwardly from the stop arrangement along the length of the guide. The camming members of the stop arrangement cam upwardly above the flanges. The flanges define a guide channel along which an end rail of a cassette can slide.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a perspective view of an example communications panel system including a chassis mounted to a rack, the chassis being configured to hold a plurality of tray arrangements;

FIG. 2 is a perspective view of an example tray arrangement configured to be mounted within the chassis of FIG. 1, the tray arrangement including a tray carrying a plurality of guides;

FIG. 3 is a front, first side perspective view of an example cassette suitable for use with the tray arrangement of FIG. 2, the cassette including a latching arrangement;

FIG. 4 is a perspective view of the first cassette of FIG. 3 with the front port members exploded outwardly from the cassette body to show front apertures and a release handle of the latching arrangement exploded outwardly from a cassette body to show a stop member of the latching arrangement;

FIG. 5 is a side elevational view of the stop member and a portion of the cassette body of FIG. 4;

FIG. 6 is a perspective view of the release handle of FIG. 4 showing an externally-facing side of the release handle, the release handle defining a camming groove having first and second ramped surfaces;

FIG. 7 is an enlarged view of the camming groove of the release handle and stop surfaces of the cassette bodSy of FIG. 3;

FIG. 8 is a perspective view of an example tray carrying the cassette of FIG. 3, the tray including a first example type of guide;

FIG. 9 is a first perspective view of the first example guide of FIG. 8;

FIG. 10 is a second perspective view of the first example guide of FIG. 8;

FIG. 11 is an end view of the first example guide of FIG. 8;

FIG. 12 is an opposite end view of the first example guide of FIG. 8;

FIG. 13 is a first side elevational view of the first example guide of FIG. 8;

FIG. 14 is a second side elevational view of the first example guide of FIG. 8;

FIG. 15 is a top plan view of the first example guide of FIG. 8;

FIG. 16 is a bottom plan view of the first example guide of FIG. 8;

FIG. 17 is a cross-sectional view of the tray and cassette of FIG. 8 taken along the 17-17 line of FIG. 8;

FIG. 18 is a perspective view of an example tray carrying the cassette of FIG. 3, the tray including a second example type of guide;

FIG. 19 is a first perspective view of the second example guide of FIG. 18;

FIG. 20 is a second perspective view of the second example guide of FIG. 18;

FIG. 21 is an end view of the second example guide of FIG. 18;

FIG. 22 is an opposite end view of the second example guide of FIG. 18;

FIG. 23 is a first side elevational view of the second example guide of FIG. 18;

FIG. 24 is a second side elevational view of the second example guide of FIG. 18;

FIG. 25 is a top plan view of the second example guide of FIG. 18;

FIG. 26 is a bottom plan view of the second example guide of FIG. 18;

FIG. 27 is a cross-sectional view of the tray and cassette of FIG. 18 taken along the 27-27 line of FIG. 18;

FIG. 28 is a perspective view of an example tray carrying the cassette of FIG. 3, the tray including a third example type of guide;

FIG. 29 is a first perspective view of the third example guide of FIG. 28;

FIG. 30 is a second perspective view of the third example guide of FIG. 28;

FIG. 31 is an end view of the third example guide of FIG. 28;

FIG. 32 is an opposite end view of the third example guide of FIG. 28;

FIG. 33 is a first side elevational view of the third example guide of FIG. 28;

FIG. 34 is a second side elevational view of the third example guide of FIG. 28;

FIG. 35 is a top plan view of the third example guide of FIG. 28;

FIG. 36 is a bottom plan view of the third example guide of FIG. 28; and

FIG. 37 is a cross-sectional view of the tray and cassette of FIG. 28 taken along the 37-37 line of FIG. 28.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

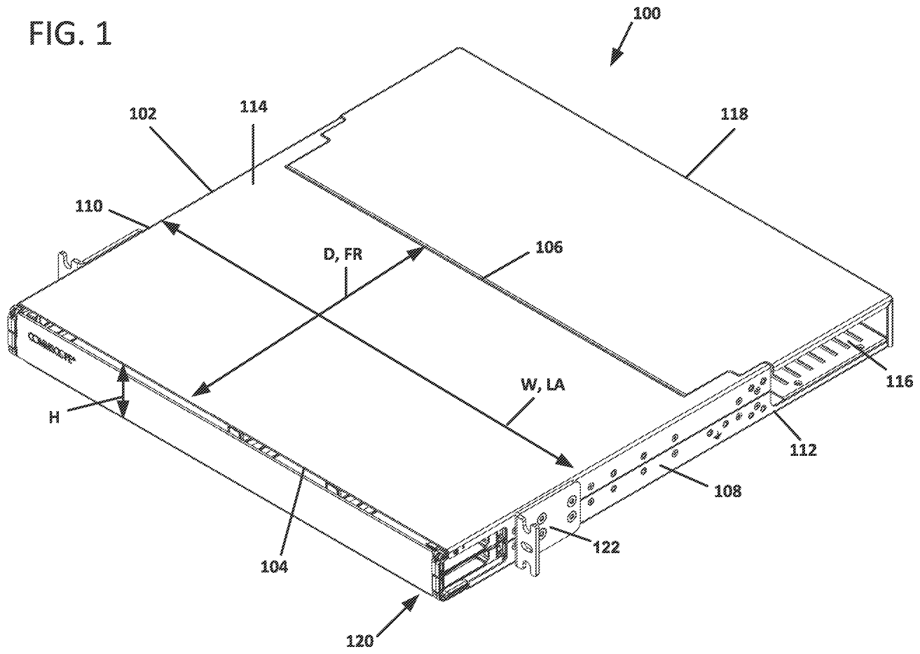

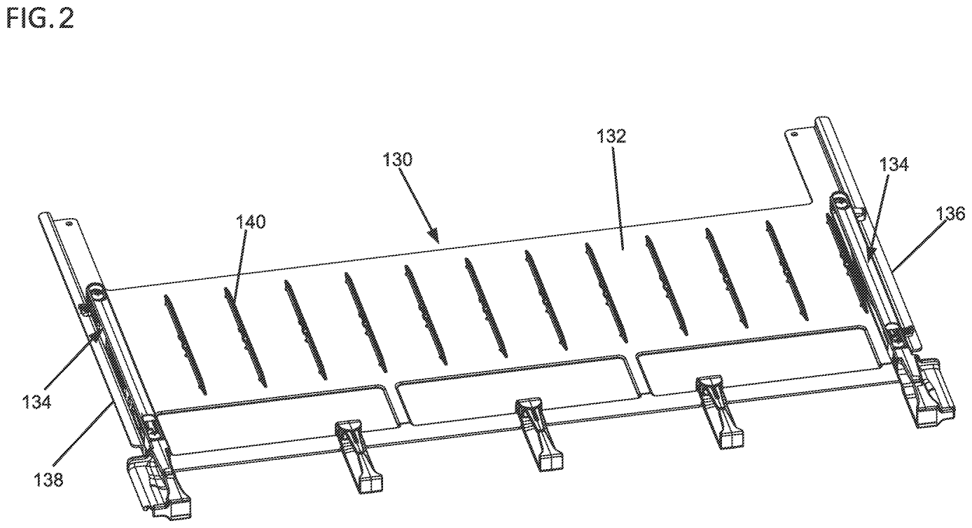

The present disclosure is directed to a communications panel 100 (e.g., see FIG. 1) configured to mount to a rack. The communications panel 100 includes a chassis holding one or more tray arrangements 310 (e.g., see FIG. 2). The chassis 102 has a depth D extending along a forward-rearward axis FR between a front 104 and a rear 106. The chassis 102 also has a width W extending along a lateral axis LA between opposite first and second sides 108, 110. The chassis 102 also has a height H extending between a bottom wall 112 and a top wall 114. In certain implementations, mounting brackets 150 are disposed at the first and second sides 108, 110 of the chassis 102. The mounting brackets 122 are configured to mount the chassis 102 to the rack.

In accordance with some aspects of the disclosure, a front door arrangement 120 is mounted at the front 104 of the chassis 102 is selectively block and allow access to an interior of the chassis 102 through the front 104. In certain implementations, a cable management section 116 is disposed at the rear 106 of the chassis 102 to manage cables extending to the chassis 102 from the rear. A removable cover 118 is mounted over the cable management section 116. In certain examples, the removable cover 118 is flush with the top panel 114 of the chassis 102. In certain examples, sides of the cable management section 116 remain uncovered to facilitate cable routing to/from the cable management section 116.

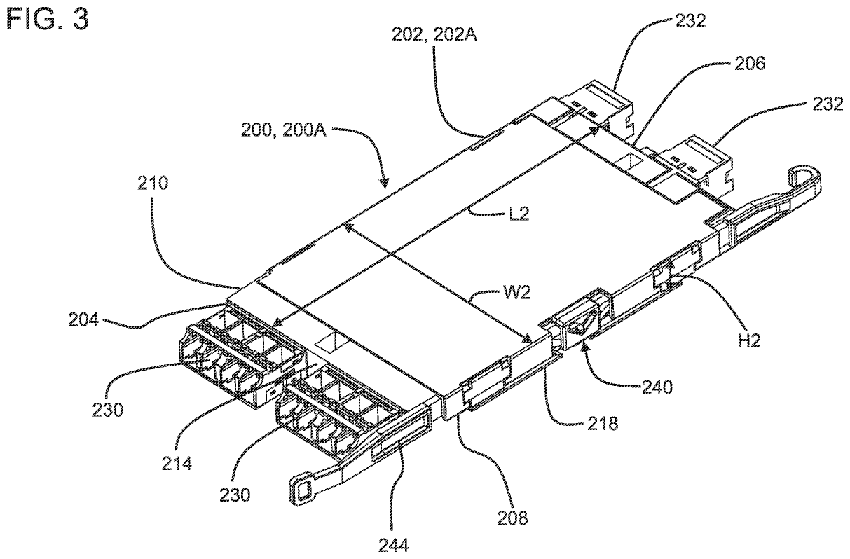

Each tray arrangement 130 spans a width W of the chassis 102. In some implementations, the tray arrangements 130 are stationary within the chassis 102. In other implementations, the tray arrangements 130 are slidable along a depth D of the chassis 102 between two or more positions. In certain examples, the tray arrangement 130 can be latched into any of the two or more positions using a latch arrangement 134. Each tray arrangement 130 is configured to support one or more cassettes 200 (e.g., see FIG. 3) carrying ports (e.g., optical ports, electrical ports, hybrid ports, etc.) configured to receive plug connectors. A tray arrangement 130 populated with one or more cassettes 200 is referred to herein as a communications arrangement.

Examples of various tray arrangements suitable for use in the chassis 102 are described in co-pending U.S. application Ser. No. 17/675,921, filed Feb. 18, 2022, and titled “Communications Panel System;” co-pending PCT application No. PCT/US2022/021949, filed Mar. 25, 2022, and titled “Communications Panel Systems and Trays Therefore;” and co-pending PCT application No. PCT/US2022/026171, filed Oct. 27, 2022, and titled “Panel System with Managed Connectivity,” the disclosures of which are hereby incorporated by reference in their entirety.

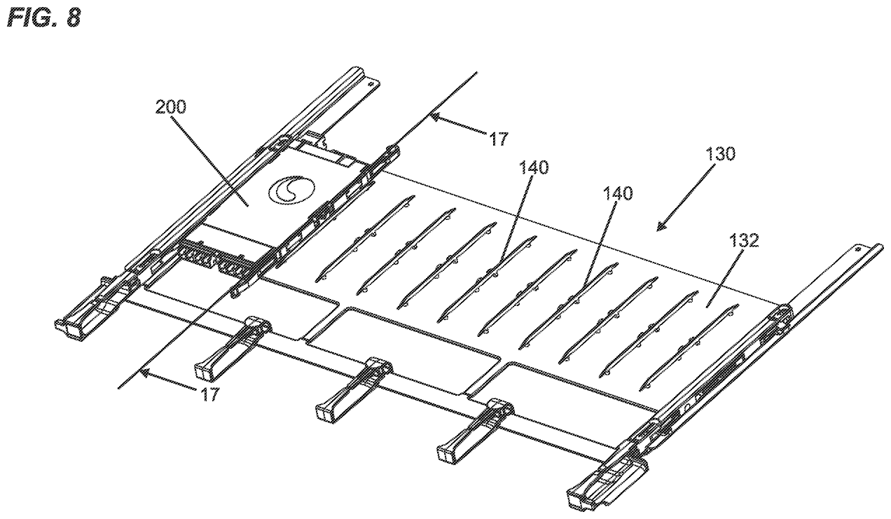

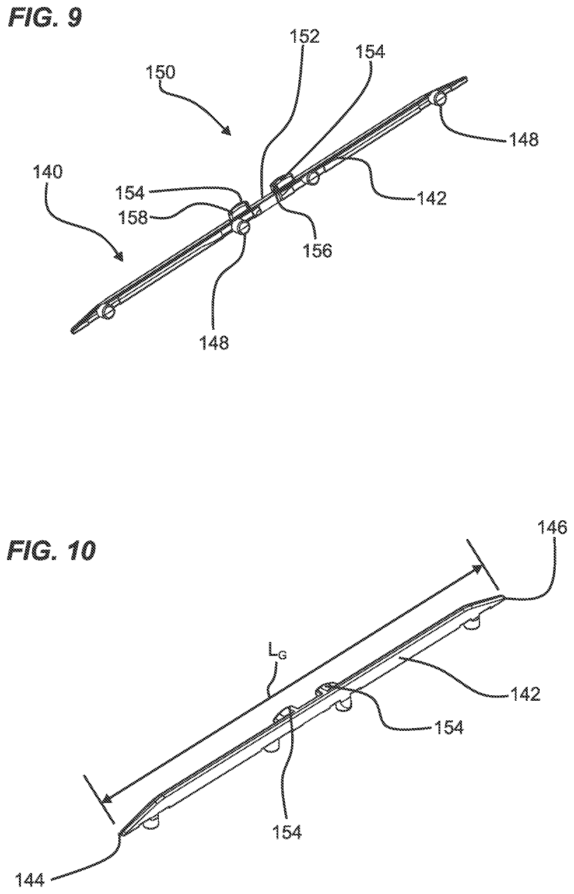

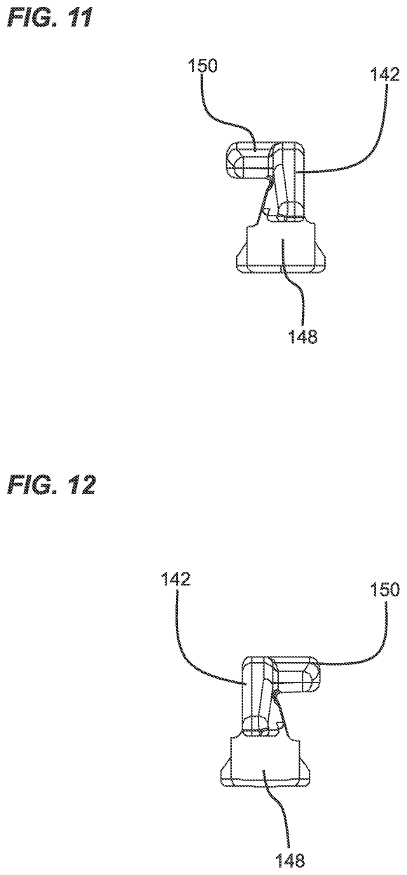

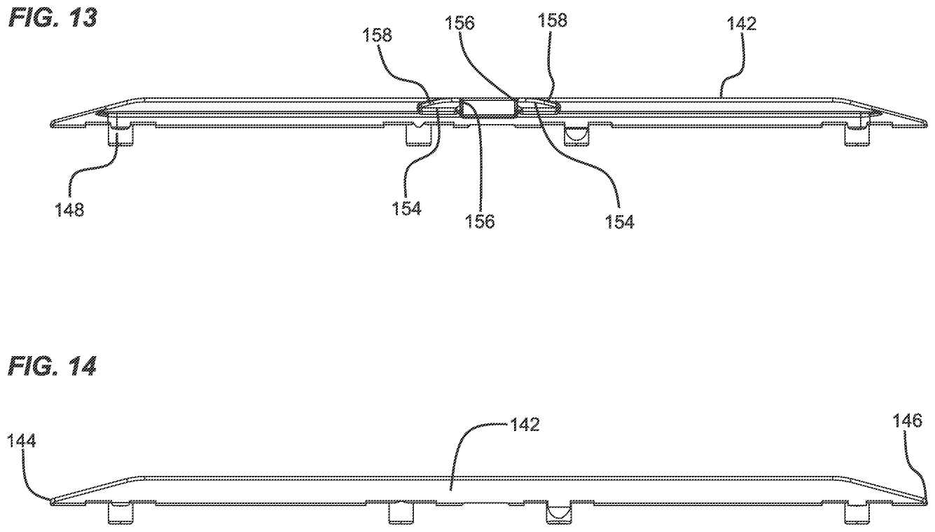

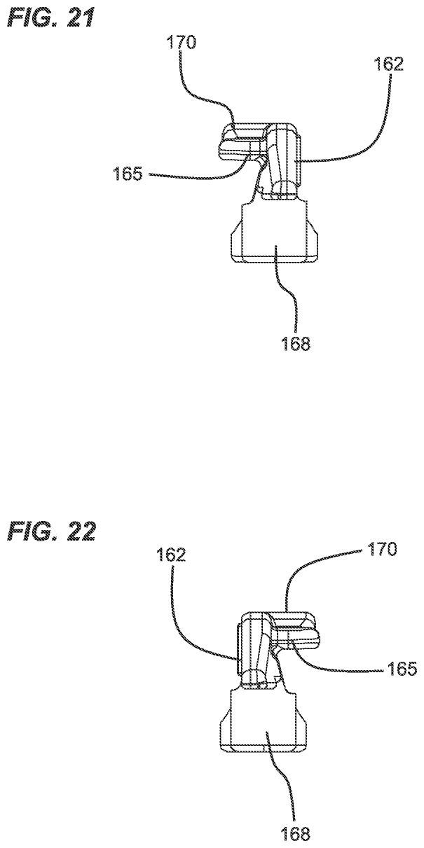

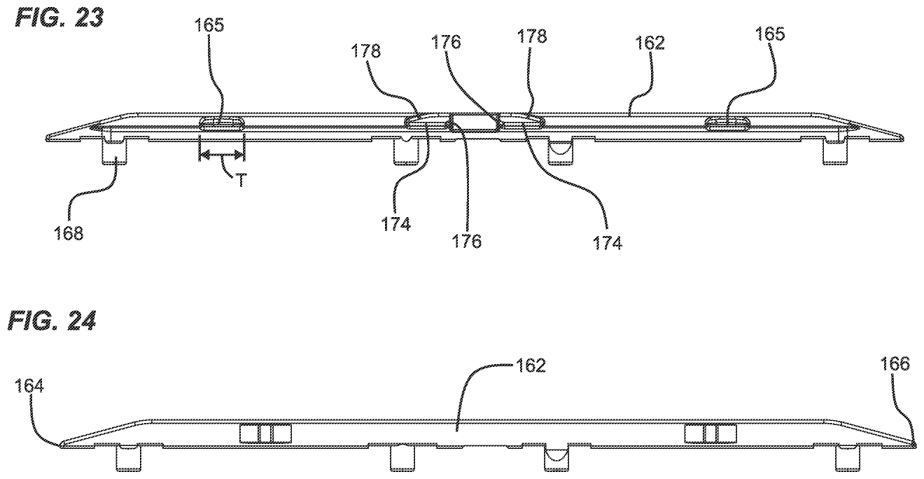

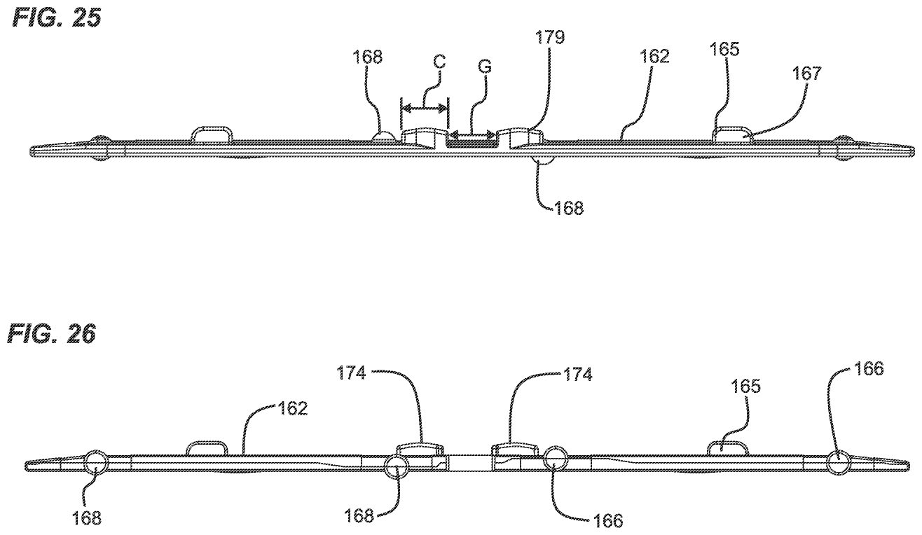

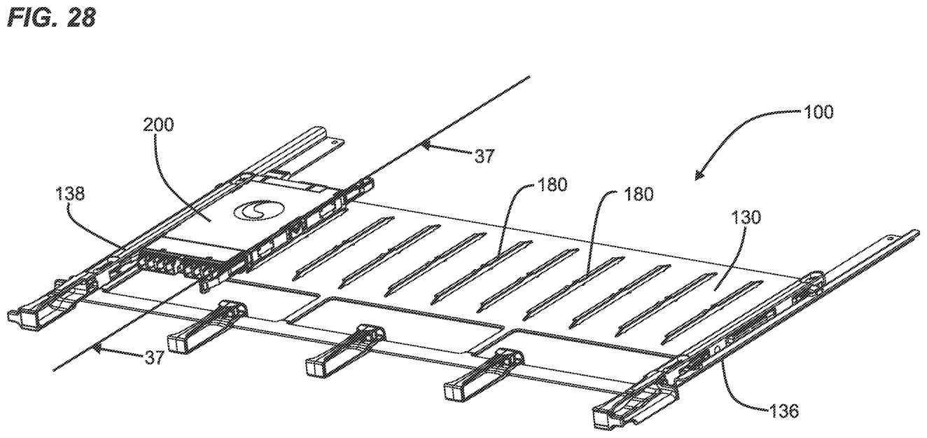

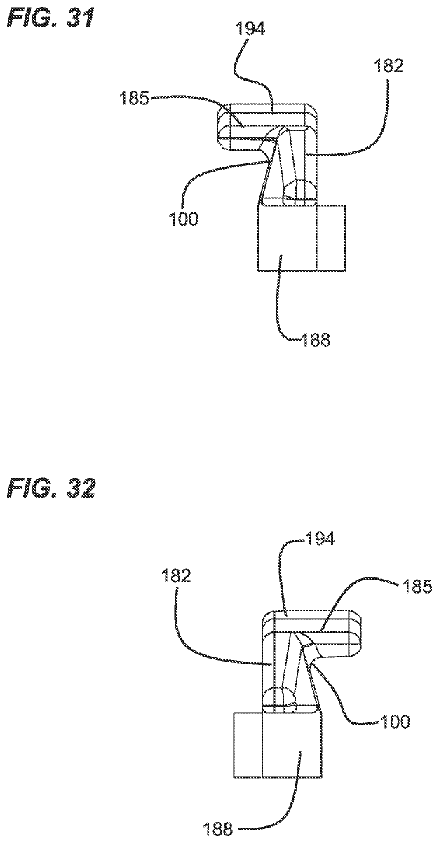

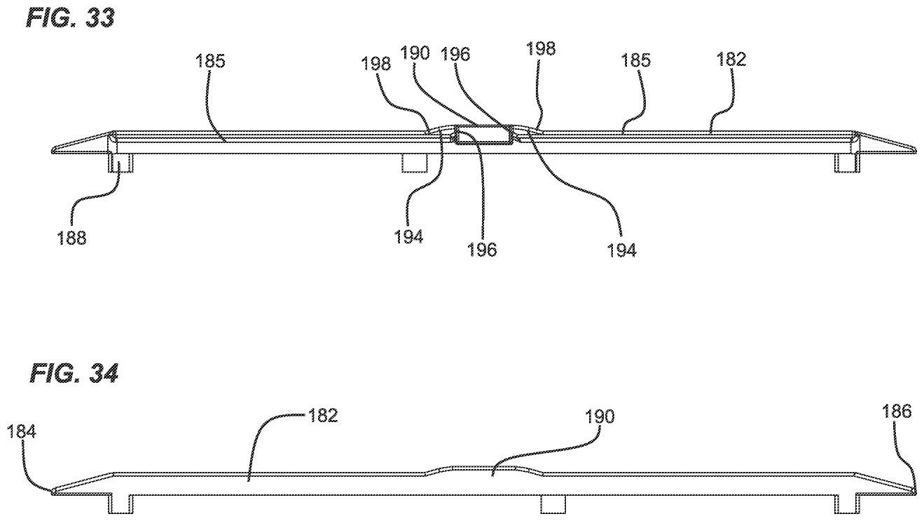

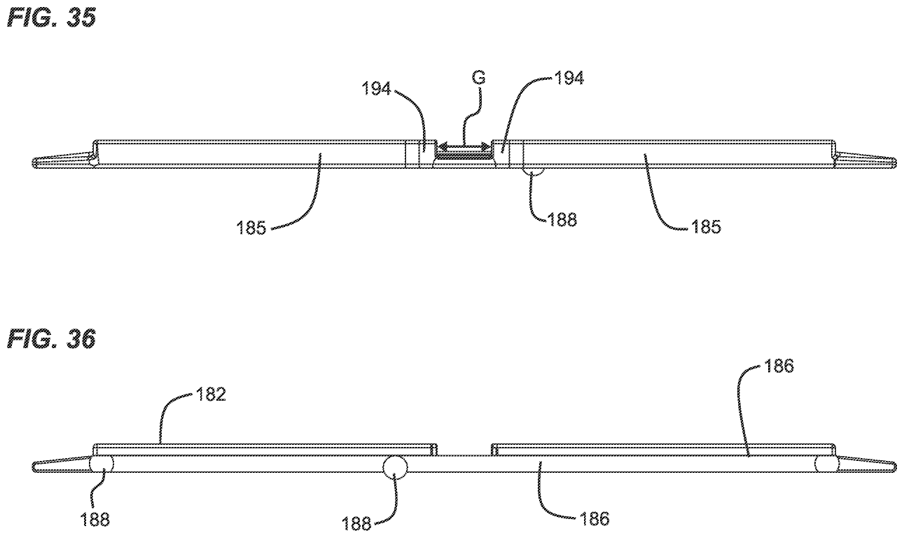

The tray arrangement 130 carries two or more guides 140, 160, 180. A first example type of guide 140 is shown in FIGS. 8-17. A second example type of guide 160 is shown in FIGS. 18-27. A third example type of guide 180 is shown in FIGS. 28-37. Each guide 140, 160, 180 extends parallel to the forward-rearward axis FR. The guides 140, 160, 180 are spaced from each other along the lateral axis LA. The guides 140, 160, 180 are configured to slidingly receive a plurality of cassettes 200 along the guides 140, 160, 180 from either the front end of the tray 130 or from the rear end of the tray 130 at a discretion of a user. Interaction between the guides 140, 160, 180 and the cassettes 200 will be discussed in more detail herein.

Each guide 140, 160, 180 includes a body 142, 162, 182 extending along a length L_{G} between a first end 144, 164, 184 and an opposite second end 146, 166, 186. In certain examples, the body 142, 162, 182 is elongate along the length L_{G}. In certain implementations, one or more posts 148, 168, 188 extend outwardly from the body 142, 162, 182. The posts 148, 168, 188 are configured to enable the guide body 142, 162, 182 to be mounted (e.g., heat staked) to the tray 130. Each body 142, 162, 182 has a first side that faces towards the first end 136 of the tray 130 and an opposite second side that faces towards the second end 138 of the tray 130. In certain examples, the first side of the body 142, 162, 182 is flat along the length L_{G}.

Each guide 140, 160, 180 includes a stop arrangement 150, 170, 190 extending outwardly from the second side of the body 142, 162, 182 towards the second side 138 of the tray 130. Each stop arrangement 150, 170, 190 includes first and second oppositely-facing camming members 154, 174, 194 spaced apart along the depth of the tray 130 by a gap G. Each of the first and second camming members 154, 174, 194 has a length C extending along length L_{G} of the guide 140, 160, 180. In certain examples, the length C of each of the first and second camming members 154, 174, 194 is less than the first distance G. In certain examples, the length C is less than a quarter of the length L_{G} of the guide 140, 160, 180. In certain examples, the length C is less than ⅛th the length L_{G} of the guide 140, 160, 180. In certain examples, the length C is less than a tenth of the length L_{G} of the guide 140, 160, 180. The camming member 154, 174, 194 define opposing stop surfaces 156, 176, 196 spaced by the first distance G. The camming members 154, 174, 194 also define camming surfaces 158, 178, 198 at opposite ends of the camming members 154, 174, 194 from the stop surfaces 156, 176, 196.

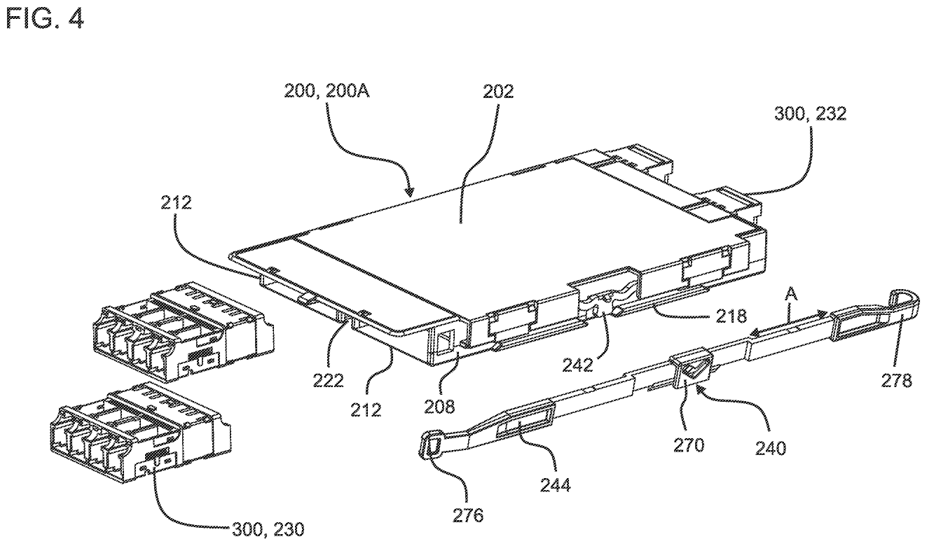

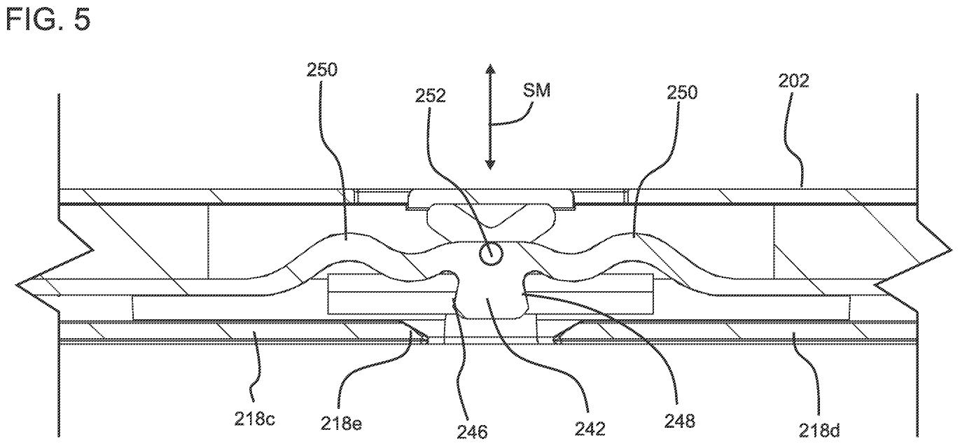

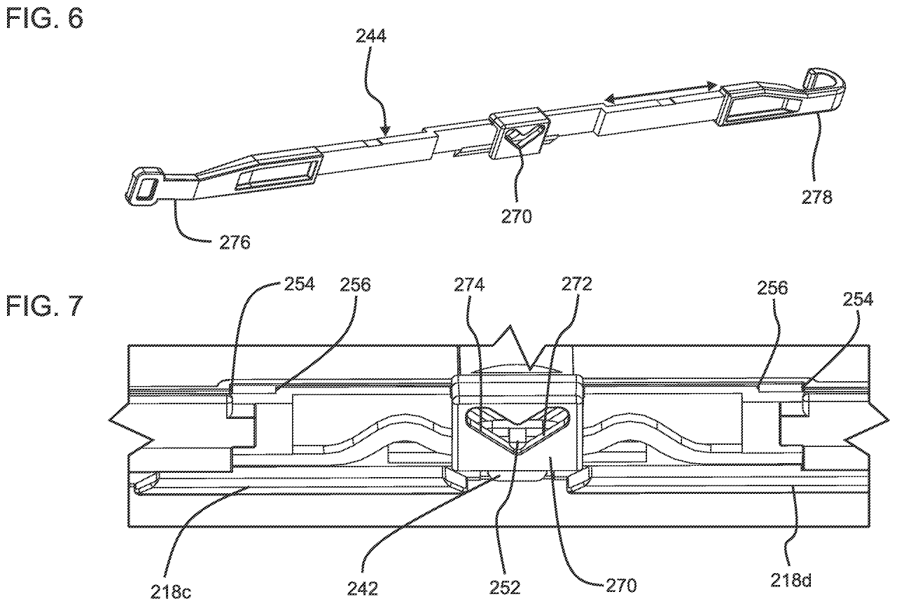

Referring to FIGS. 3-7, a cassette 200 carries one or more front ports 230 at front apertures 212 at a front of the cassette 200. The front ports 230 are configured to receive plug connectors. In some implementations, the front ports 230 are optical ports configured to receive optical plug connectors. In other implementations, the front ports 230 may be electrical ports configured to receive electrical plug connectors, hybrid ports configured to receive hybrid plug connectors, or a mixture thereof. In some implementations, a cassette 200 carries single-fiber front ports 230 (e.g., LC front ports). In other implementations, a cassette 200 carries multi-fiber front ports 230 (e.g., MPO front ports, SN front ports offered by Senko, etc.). In still other implementations, the same cassette 200 may carry a mix of two or more types of front ports 230 (e.g., a mixture of MPO and LC ports).

In some implementations, the cassette 200 carries one or more rear ports 232 (e.g., optical port, electrical port, hybrid port, etc.) at the rear of the cassette 200. Each rear port 232 is configured to receive a plug connector. Intermediate optical fibers within the cassette 200 connect the front and rear ports 230, 232. In other implementations, the cassette 200 carries ports only at the front of the cassette 200. In such implementations, a rear of the cassette 200 is configured to enable optical fibers or one or more optical fiber cables to extend into/onto the cassette 200 and be routed towards the front ports 230.

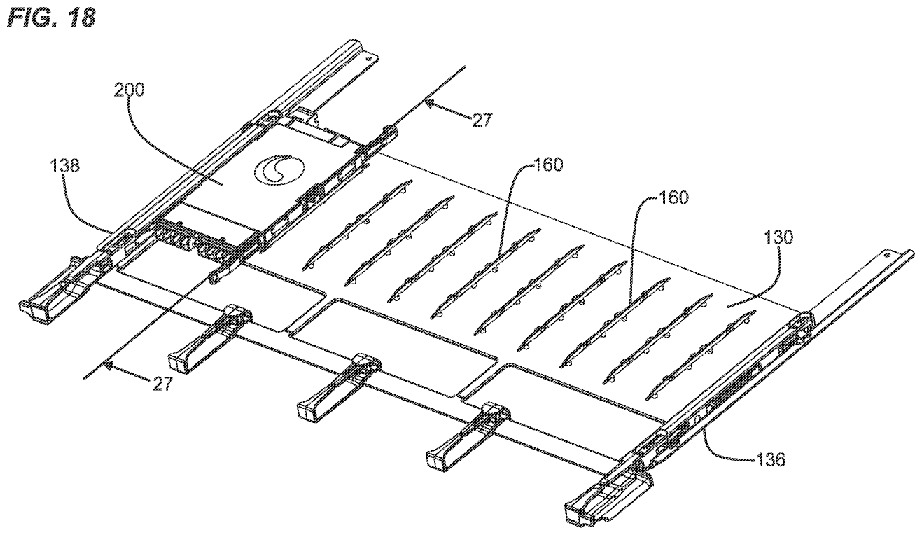

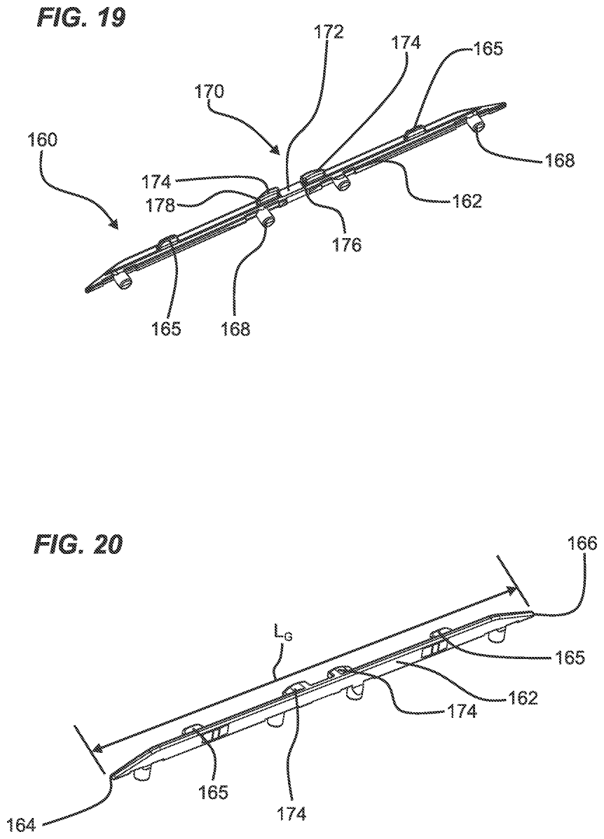

The cassettes 200 are slidably mounted to the tray arrangement 130 along guides 140, 160, 180. In certain implementations, the cassette 200 includes a cassette body 202 that extends along a width W2 between opposite first and second ends 208, 210, along a length L2 between front and rear ends 204, 206, and along a height H2 (FIG. 19) between a bottom and a top. The length L2, width W2, and height H2 are orthogonal to each other. The cassette body 202 defines one or more bottom channels 222 extending along the length L2 of the cassette body 202. The bottom channels 222 are sized to receive guides 140, 160, 180 to enable a cassette 200 to extend over one or more guides 140, 160, 180. In certain implementations, each cassette 200 includes an end rail 218 at one side and a bottom rail disposed within the bottom channel 222. The second end 210 of the cassette body 202 is not configured to engage a guide 140, 160, 180. Additional information about the bottom rail of the cassette is provided in U.S. application Ser. No. 17/675,921, incorporated by reference above.

In certain implementations, the cassettes 200 are configured to lock to the guides 140, 160, 180 (e.g., to the stop arrangement 150, 170, 190) in at least one discrete position. Each cassette 200 includes a latching arrangement 240 that includes a stop member 242 configured to drop into the gap G of the stop arrangement 150, 170, 190 of the respective guide 140, 160, 180 to lock the cassette 200 to the guide 140, 160, 180. The latching arrangement 240 also includes a release handle 244 to raise the stop member 242 out of the gap. The stop member 242 is carried by the cassette body 202 at the first end 208. The stop member 242 is movable relative to the cassette body 202 along a movement axis SM that extends parallel to the height H2 of the cassette 200. In certain implementations, the stop member 242 is movable along the movement axis SM between a lock position and a release position. In certain examples, the stop member 242 is biased to the lock position (e.g., using spring arms 250).

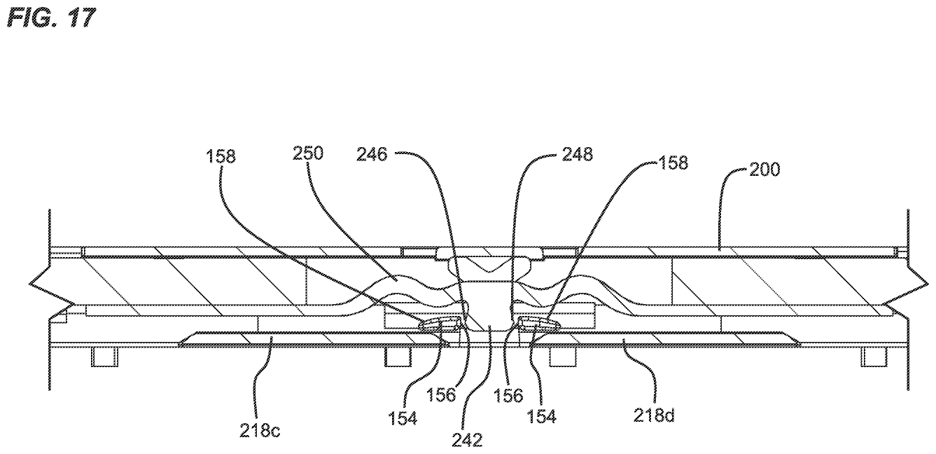

When in the lock position (e.g., see FIG. 17), engagement surfaces 246, 248 of the stop member 242 extend at least partially through the gap G of the stop arrangement 150, 170, 190. The first engagement surface 246 is configured to oppose the stop surface 156, 176, 196 of the first camming member 154, 174, 194 and the second engagement surface 248 is configured to oppose the stop surface 156, 176, 196 of the second camming member 154, 174, 194. Abutment between the first engagement surface 246 and the stop surface 156, 176, 196 of the first camming member 154, 174, 194 inhibits forward movement of the cassette 200 along the guides 140, 160, 180. Abutment between the second engagement surface 248 and the stop surface 156, 176, 196 of the second camming member 154, 174, 194 inhibits rearward movement of the cassette 200 along the guide 140, 160, 180. When in the release position, the engagement surfaces 246, 248 of the stop member 242 are raised out of the gap 152, 172, 192 sufficient so that the engagement surfaces 246, 248 do not abut the stop surfaces of the camming members 154, 174, 194 upon movement of the cassette 200 relative to the guide 140, 160, 180.

The release handle 244 is configured to move relative to the cassette body 202 along an actuation axis A between a neutral position and a forward extended position. When in the neutral position, the release handle 244 enables the stop member 242 to be in the lock position. When moved to the forward extended position, the release handle 244 transitions the stop member 242 to the release position. In certain implementations, the release handle 244 also can be moved relative to the cassette body 202 along the actuation axis A to a rearward extended position. When moved to the rearward extended position, the release handle 244 transitions the stop member 242 to the release position. Further information about the operation of the release handle is provided in U.S. application Ser. No. 17/675,921, incorporated by reference above.

In certain implementations, the stop member 242 rides over the camming surface 158 of one of the camming members 154, 174, 194 as the cassette 200 is slid along the guide 140, 160, 180. Because the camming member 154, 174, 194 is so short compared to the length L_{G} of the guide 140, 160, 180, the spring arms 250 of the stop member 242 are stressed for only a short period of time. Limiting the stress applied to the spring arms 250 inhibits deformation or other wear on the spring arms 250, thereby enhancing the longevity of the latching arrangement 240.

In certain implementations, when the cassette 200 is positioned along the guide 140, 160, 180 so that the latching arrangement 240 of the cassette 200 engages the stop arrangement 150, 170, 190 of the guide 140, 160, 180, the end rail 218 will extend at least partially below the camming members 156, 176, 196 of the stop arrangement 150, 170, 190. In certain implementations, the end rail 218 of the cassette 200 includes a front end rail 218c and a rear end rail 218d aligned along the length L2 of the cassette 200 (e.g., see FIG. 17). The rear end rail 218d is spaced from the front end rail 218c along the length L2 of the cassette 200. In such implementations, an inner end of the front rail 218c extends partially under a front one of the camming members 154, 174, 194; an inner end of the rear rail 218d extends partially under a rear one of the camming members 154, 174, 194 (e.g., see FIG. 17). Engagement between the end rail 218 and the camming members 154, 174, 194 inhibit lifting of the cassette 200 from the tray 130 while the cassette 200 is latched to the guide 140, 160, 180. Instead, the cassette 200 is slid forward or rearward along the guide 140, 160, 180 relative to the tray 130 until the end rail 218 clears the stop arrangement 150, 170, 190 to lift the cassette 200 from the tray 13.

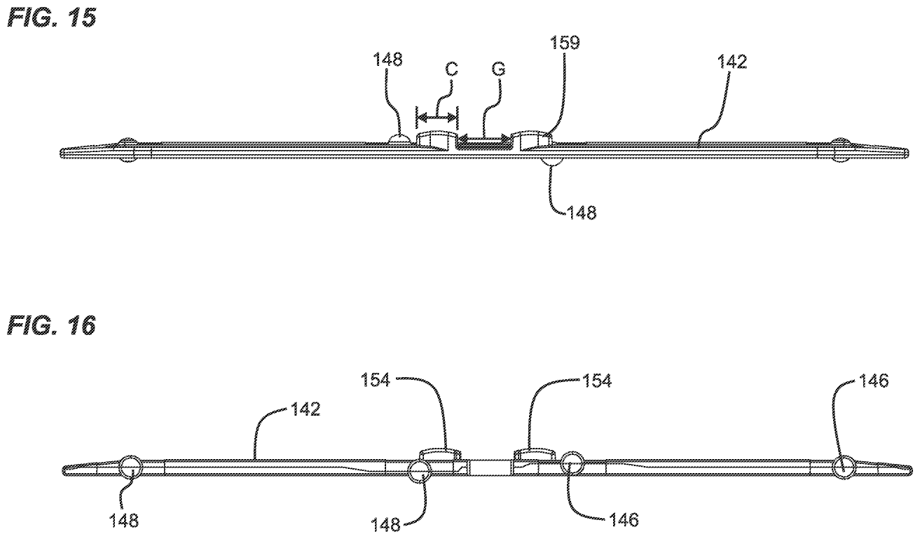

In certain implementations, the camming surface 158, 178, 198 of each camming member 154, 174, 194 faces partially along the depth D of the chassis 102 and partially upwardly from the tray 130. In certain implementations, each camming member 154, 174, 194 defines a second camming surface 159, 179, 199 (e.g., see FIG. 15) that faces partially along the depth D of the chassis 102 and partially along the width W of the chassis 102. The second camming surface 159, 179, 199 further aids in directing the cassette 200 as the cassette 200 slides along the guide 140, 160, 180.

As shown in FIGS. 8-17, the first type of guide 140 includes only the stop arrangement 150 extending outwardly from the guide body 142 towards the second side 138 of the tray 130.

As shown in FIGS. 18-27, the second type of guides 160 include end tabs 165 that extend outwardly from the guide body 162 in the same direction as the stop arrangement 170. In certain implementations, the end tabs 162 includes a forward end tab 165 disposed between the first end 164 of the guide 160 and the stop arrangement 170 and a rearward end tab 165 disposed between the stop arrangement 170 and the second end 166 of the guide 160. In certain implementations, each end tab 165 is spaced inwardly from the ends 164, 166 of the guide 160. In certain implementations, each tab 165 is spaced outwardly from the stop arrangement 170.

In certain implementations, the end tabs 165 help to orient the cassette 200 relative to the guide 160 to facilitate sliding of the cassette 200 along the guide 160. In certain examples, the end tabs 165 inhibit torquing of the cassette 200 side-to-side while sliding the cassette 200 along the guide 160. In certain implementations, each end tab 165 extends outwardly from the guide body 160 no farther than the stop arrangement 170 does. In certain implementations, each end tab 165 has a length T that is less than the gap G of the stop arrangement 170. In certain examples, the length T of each end tab 165 is less than a quarter of the length L_{G} of the guide 160. In certain examples, the length T is less than ⅛th the length L_{G} of the guide 160. In certain examples, the length T is less than a tenth of the length L_{G} of the guide 160. In certain examples, each of the first and second tabs 165 contours inwardly towards the guide body 162 as the front and rear end tabs 165 extend away from each other. The contoured surface facilitates sliding of the cassette 200 past the end tabs 165.

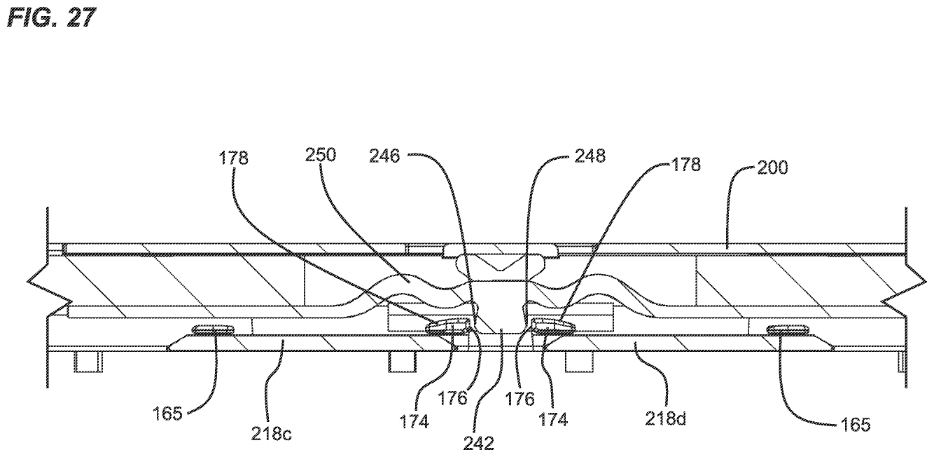

Referring to FIG. 27, in certain implementations, the end tabs 165 are positioned so that the end rail 218 of the cassette 200 extends at least partially beneath the end tabs 165 when the cassette 200 is positioned at the tray so that the latching arrangement 240 of the cassette 200 aligns with the stop arrangement 170 of the guide 160. In certain examples, engagement between the end tabs 165 and the end rail 218 inhibit lifting of the cassette 200 from the tray 130. In certain examples, engagement between the end tabs 165 and the end rail 218 inhibits torquing the cassette 200 upwardly from the tray 130. In certain implementations, the end tabs 165 are spaced from the stop arrangement 170 so that the forward end rail 218c of the cassette 200 extends beneath both the forward end tab 165 and the front camming member 174 of the stop arrangement 170 and the rearward end rail 218d of the cassette 200 extends beneath both the rear camming member 174 of the stop arrangement 170 and the rearward end tab 165.

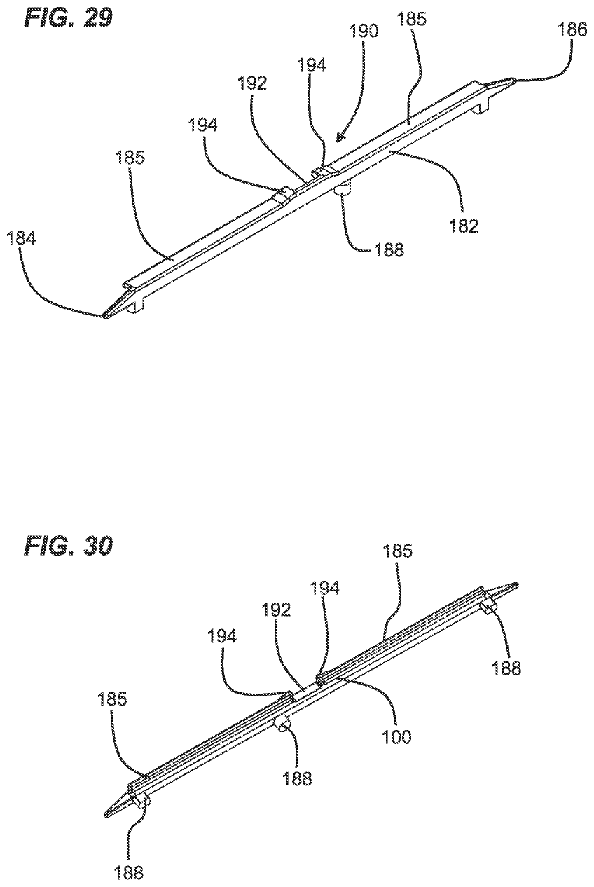

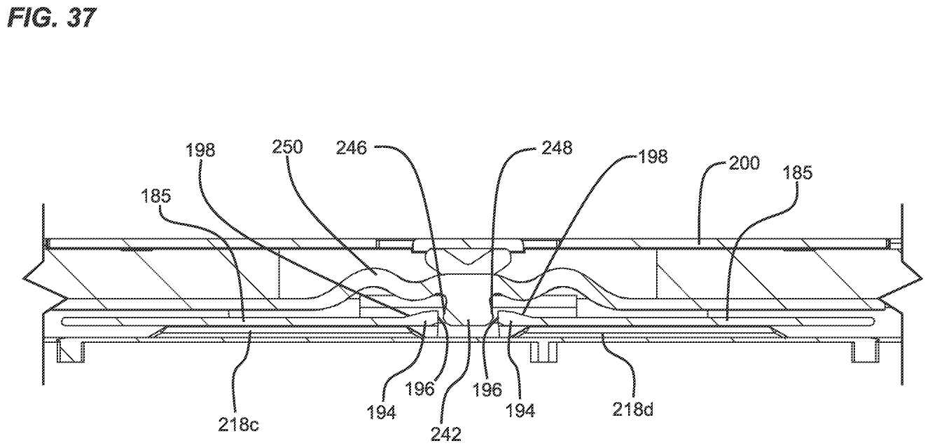

As shown in FIGS. 28-37, the third type of guides 180 include forward and rearward flanges 185 extending outwardly from the body 182 in the same direction as the stop arrangement 190. In certain implementations, each flange 185 extends outwardly from the stop arrangement 190 along the length L_{G} of the guide 180 to define a channel 100. The camming members 194 of the stop arrangement 190 begin camming upwardly from the rails 185 (see FIGS. 29 and 37).

In certain implementations, the flanges 185 help to orient the cassette 200 relative to the guide 180 to facilitate sliding of the cassette 200 along the guide 180. In certain examples, the flanges 185 inhibit torquing of the cassette 200 side-to-side while sliding the cassette 200 along the guide 180. In certain implementations, each flange 185 extends outwardly from the guide body 180 no farther than the stop arrangement 190 does. In some implementations, the flanges 185 extend outwardly to the ends 184, 186 of the guide 180. In other implementations, however, the flanges 185 terminate before the ends 184, 186 of the guide 180. In certain examples, the ends 184, 186 of the guide 180 taper downwardly from ends of the flanges 185.

Referring to FIG. 37, in certain implementations, the flanges 185 are positioned so that the end rail 218 of the cassette 200 extends at least partially beneath the flanges 185 when the cassette 200 is positioned at the tray so that the latching arrangement 240 of the cassette 200 aligns with the stop arrangement 190 of the guide 180. In certain examples, engagement between the flanges 185 of the guide 180 and the end rail 218 of the cassette 200 inhibits lifting of the cassette 200 from the tray 130. In certain examples, engagement between the flanges 185 of the guide 180 and the end rail 218 of the cassette 200 inhibits torquing the cassette 200 upwardly from the tray 130. In certain implementations, the forward end rail 218c of the cassette 200 extends beneath both the front flange 185 and the front camming member 174 of the stop arrangement 170 and the rearward end rail 218d of the cassette 200 extends beneath both the rear camming member 174 of the stop arrangement 170 and the rear flange 185.

Examples of the disclosure may be described according to the following aspects.
Aspect 1: A tray arrangement comprising:
   a body having oppositely-facing first and second major surfaces separated by a thickness, the first and second major surfaces extending along a depth between a front and a rear of the body and along a width between opposite first and second sides of the body, the width being transverse to the depth; and
   a plurality of guides laterally spaced apart along the width of the body at the first major surface, each guide being elongate along the depth of the first major surface between opposite first and second ends of the guide, each guide having a flat surface facing towards the first side of the body, each guide including a stop arrangement extending outwardly towards the second side of the body, each stop arrangement including first and second oppositely-facing camming members spaced apart along the depth of the body by a first distance, each of the first and second camming members having a length extending along the depth of the body, the length of each of the first and second camming members being less than the first distance, the first camming member defining a first stop surface and the second camming member defining a second stop surface that opposes the first stop surface.
Aspect 2. The tray arrangement of aspect 1, wherein a respective first tab extends outwardly from each guide towards the second side of the body, the first tab being spaced along the depth of the body between the respective first camming member and the respective first end of the guide; and wherein a respective second tab extends outwardly from each guide towards the second side of the body, the second tab being spaced along the depth of the body between the respective second camming member and the respective second end of the guide.
Aspect 3. The tray arrangement of aspect 2, wherein each of the first and second tabs contours inwardly towards the guide as the first and second tabs extend away from each other.
Aspect 4. The tray arrangement of aspect 2, wherein each of the first and second tabs has a length extending along the depth of the body, the length of each of the first and second tabs being less than the first distance.
Aspect 5. The tray arrangement of any of aspects 1-4, wherein each of the first and second camming members contours inwardly towards the guide as the first and second camming members extend away from each other.
Aspect 6. The tray arrangement of aspect 1, wherein a respective first flange extends along the depth of the base from the first camming member of each guide towards the respective first end; and wherein a respective second flange extends along the depth of the base from the second camming member of each guide towards the respective second end.
Aspect 7. The tray arrangement of any of aspects 1-6, wherein each guide includes a plurality of pegs that extend into holes through the body to hold the guide to the body.
Aspect 8. The tray arrangement of any of aspects 1-7, wherein the first and second ends of the guides are tapered.
Aspect 9. The tray arrangement of aspect 8, wherein the first and second ends of the guides taper towards the first surface of the body of the tray as the first and second ends extend away from each other.
Aspect 10. The tray arrangement of aspect 8, wherein the first and second ends of the guides taper to become thinner as the first and second ends extend away from each other.
Aspect 11. The tray arrangement of any of aspects 1-10, wherein each guide has a thickness extending along the width of the body, and wherein each guide defines a notch cut into the thickness of the guide, the notch facing towards the second side of the body, and the notch spanning between the first and second camming members of the guide.
Aspect 12. A communications arrangement comprising:
   a tray body having a depth, a width, and a thickness;
   a plurality of guides laterally spaced apart along the width of the tray body, each having a length extending between opposite first and second ends of the guide, the length of each guide being parallel with the depth of the tray body, each guide having a flat surface facing towards a first side of the tray body, and each guide including a stop arrangement extending outwardly towards a second side of the tray body, each stop arrangement including a first camming member having a first ramped surface and a first stop surface, the first ramped surface facing at least partially towards a front of the tray body, and the first stop surface facing towards a rear of the tray body, the first ramped surface having a length that is less than a tenth the length of the guide; and
   a cassette that mounted to the tray body.
Aspect 13. The communications arrangement of aspect 12, wherein the cassette carries a stop member that is movable along a direction parallel with the thickness of the tray body, the stop member being located on the cassette so that the stop member aligns with the respective stop arrangement when the cassette is disposed at a first of the guides.
Aspect 14. The communications arrangement of aspect 12 or aspect 13,wherein each stop arrangement also includes a second camming member having a second ramped surface and a second stop surface, the second ramped surface facing at least partially towards the rear of the tray body, and the second stop surface facing towards the front of the tray body, the second ramped surface having a length that is less than a tenth the length of the guide.
Aspect 15. The communications arrangement of aspect 14, wherein the second ramped surface has the same length as the first ramped surface.
Aspect 16. The communications arrangement of aspect 14, wherein the second stop surface is spaced a first distance from the first stop surface, and wherein the first distance is longer than the length of the first ramped surface.
Aspect 17. The communications arrangement of aspect 16, and preferably of aspects 13 and 16, wherein the stop member fits within the first distance between the first and second stop surfaces.
Aspect 18. The communications arrangement of any of aspects 12-17, wherein a first tab is disposed between the stop arrangement and the first end of a first of the guides, the first tab being spaced from the stop arrangement and spaced from the first end of the first guide.
Aspect 19. The communications arrangement of aspect 18, and preferably of aspects 13 and 18, wherein the first tab abuts a side of the cassette to orient the side of the cassette parallel to the first guide.
Aspect 20. The communications arrangement of any of aspects 12-17, wherein a first flange extends outwardly along the length of a first of the guides from the respective stop arrangement towards the respective first end.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

1. A tray arrangement comprising:
a body having oppositely-facing first and second major surfaces separated by a thickness, the first and second major surfaces extending along a depth between a front and a rear of the body and along a width between opposite first and second sides of the body, the width being transverse to the depth; and
a plurality of guides laterally spaced apart along the width of the body at the first major surface, each guide being elongate along the depth of the first major surface between opposite first and second ends of the guide, each guide having a flat surface facing towards the first side of the body, each guide including a stop arrangement extending outwardly towards the second side of the body, each stop arrangement including first and second oppositely-facing camming members spaced apart along the depth of the body by a first distance, each of the first and second camming members having a length extending along the depth of the body, the length of each of the first and second camming members being less than the first distance, the first camming member defining a first stop surface and the second camming member defining a second stop surface that opposes the first stop surface.

2. The tray arrangement of claim 1, wherein a respective first tab extends outwardly from each guide towards the second side of the body, the first tab being spaced along the depth of the body between the respective first camming member and the respective first end of the guide; and wherein a respective second tab extends outwardly from each guide towards the second side of the body, the second tab being spaced along the depth of the body between the respective second camming member and the respective second end of the guide.

3. The tray arrangement of claim 2, wherein each of the first and second tabs contours inwardly towards the guide as the first and second tabs extend away from each other.

4. The tray arrangement of claim 2, wherein each of the first and second tabs has a length extending along the depth of the body, the length of each of the first and second tabs being less than the first distance.

5. The tray arrangement of claim 1, wherein each of the first and second camming members contours inwardly towards the guide as the first and second camming members extend away from each other.

6. The tray arrangement of claim 1, wherein a respective first flange extends along the depth of the base from the first camming member of each guide towards the respective first end; and wherein a respective second flange extends along the depth of the base from the second camming member of each guide towards the respective second end.

7. The tray arrangement of claim 1, wherein each guide includes a plurality of pegs that extend into holes through the body to hold the guide to the body.

8. The tray arrangement of claim 1, wherein the first and second ends of the guides are tapered.

9. The tray arrangement of claim 8, wherein the first and second ends of the guides taper towards the first surface of the body of the tray as the first and second ends extend away from each other.

10. The tray arrangement of claim 8, wherein the first and second ends of the guides taper to become thinner as the first and second ends extend away from each other.

11. The tray arrangement of claim 1, wherein each guide has a thickness extending along the width of the body, and wherein each guide defines a notch cut into the thickness of the guide, the notch facing towards the second side of the body, and the notch spanning between the first and second camming members of the guide.

12. A communications arrangement comprising:
a tray body having a depth, a width, and a thickness;
a plurality of guides laterally spaced apart along the width of the tray body, each having a length extending between opposite first and second ends of the guide, the length of each guide being parallel with the depth of the tray body, each guide having a flat surface facing towards a first side of the tray body, and each guide including a stop arrangement extending outwardly towards a second side of the tray body, each stop arrangement including a first camming member having a first ramped surface and a first stop surface, the first ramped surface facing at least partially towards a front of the tray body, and the first stop surface facing towards a rear of the tray body, the first ramped surface having a length that is less than a tenth the length of the guide; and
a cassette that mounted to the tray body.

13. The communications arrangement of claim 12, wherein the cassette carries a stop member that is movable along a direction parallel with the thickness of the tray body, the stop member being located on the cassette so that the stop member aligns with the respective stop arrangement when the cassette is disposed at a first of the guides.

14. The communications arrangement of claim 12, wherein each stop arrangement also includes a second camming member having a second ramped surface and a second stop surface, the second ramped surface facing at least partially towards the rear of the tray body, and the second stop surface facing towards the front of the tray body, the second ramped surface having a length that is less than a tenth the length of the guide.

15. The communications arrangement of claim 14, wherein the second ramped surface has the same length as the first ramped surface.

16. The communications arrangement of claim 14, wherein the second stop surface is spaced a first distance from the first stop surface, and wherein the first distance is longer than the length of the first ramped surface.

17. The communications arrangement of claim 16, wherein the stop member fits within the first distance between the first and second stop surfaces.

18. The communications arrangement of claim 12, wherein a first tab is disposed between the stop arrangement and the first end of a first of the guides, the first tab being spaced from the stop arrangement and spaced from the first end of the first guide.

19. The communications arrangement of claim 18, wherein the first tab abuts a side of the cassette to orient the side of the cassette parallel to the first guide.

20. The communications arrangement of claim 12, wherein a first flange extends outwardly along the length of a first of the guides from the respective stop arrangement towards the respective first end.
